(19) United States
(12) Patent Application Publication
(10) Pub. No.: US 2026/0270099 A1
(43) Pub. Date: Sep. 10, 2026

(54) ALLOCATION OF NETWORK RESOURCES BASED ON DELAY INFORMATION

(71) Applicant: InterDigital Patent Holdings, Inc., Wilmington, DE (US)

(72) Inventors: Achref Methenni, Montreal (CA); Michael Starsinic, Newtown, PA (US); Xavier De Foy, Kirkland (CA); Ahmed Hamza, Coquitlam (CA); Magurawalage Chathura Madhusanka Sarathchandra, London (GB); Rocco Di Girolamo, Laval (CA); Samir Ferdi, Kirkland (CA)

(73) Assignee: InterDigital Patent Holdings, Inc., Wilmington, DE (US)

(21) Appl. No.: 19/164,732

(22) PCT Filed: Apr. 4, 2024
(86) PCT No.: PCT/US2024/023089

§ 371 Date: Sep. 12, 2025

Related U.S. Application Data
(60) Provisional application No. 63/457,512, filed on Apr. 6, 2023.

(51) Int. Cl. H04L 12/14

(52) U.S. Cl. CPC H04L 12/1407

(57) ABSTRACT

A device (e.g., at least one network entity) may receive a message. The message may include round-trip (RT) latency requirements. The RT latency requirements may include uplink delay information and/or downlink delay information. The device may generate first policy charging and control (PCC) rules, for example based on the uplink delay information and/or the downlink delay information. The device may send first information indicating the first PCC rules, for example to a session management function (SMF). The device may receive a notification that one or more of an uplink delay and/or a downlink delay is associated with a flow. The device may determine second PCC rules, for example based on the uplink delay information and the downlink delay information. The device may send second information indicating the second PCC rules, for example to the SMF.

### CROSS-REFERENCE TO RELATED APPLICATIONS

This application claims the benefit of U.S. Provisional Application No. 63/457,512 filed on Apr. 6, 2023, the entire contents of which are incorporated herein by reference.

### BACKGROUND

An application function (AF) may provide protocol data unit (PDU) set related assistance information for dynamic policy charging and control (PCC). Parameters may be included in PDU Set QoS parameters. One parameter may include a PDU Set delay budget (PSDB). A PSDB may include an upper bound for the delay that a PDU Set may experience for the transfer between a wireless transmit/receive unit (WTRU) and the N6 termination point at the UPF, for example the duration between the reception time of the first PDU and the time when all PDUs of a PDU Set have been successfully received.

### SUMMARY

This disclosure pertains to devices, methods, and systems for allocating network resources based on delay requirements of extended reality and media (XRM) traffic. Devices, methods, and systems for latency and coverage enhancement for allocation of network resources, and in particular, allocation of network resources based on delay requirements of XRM traffic are provided herein.

The devices, methods, and systems relate to, for example, round-trip (RT) time requirements with uplink and downlink delay limits. The devices, methods, and systems relate to, for example, determining QoS requirements based on PDU set attributes. In one or more cases, the devices, methods, and systems receive a message comprising RT latency requirements, in which the RT latency requirements comprise uplink delay information and downlink delay information. In one or more cases, the devices, methods, and systems use the uplink delay information and downlink delay information to create policy charging and control (PCC) rules and send the PCC rules to a session management function (SMF). In one or more cases, the devices, methods, and systems receive a notification that the delay that is associated with a flow is not within the range that is required by the PCC rule. In one or more cases, the devices, methods, and systems perform, based on the received notification, one of: using the uplink delay information and downlink delay information to determine new PCC rules and sending the new PCC rules to the SMF; determining that PCC rules that meet all of the requirements that are indicated in the RT latency requirements, uplink delay information and downlink delay information cannot be created and, based on the determination, sending a notification to an AF; and determining a new set of RT latency requirements, uplink delay information and downlink delay information, calculating new PCC rules based on the new set of RT latency requirements, uplink delay information and downlink delay information, using the new uplink delay information and downlink delay information to determine new PCC rules, and sending the new PCC rules to the SMF.

A device (e.g., at least one network entity) may receive a message. The message may include round-trip (RT) latency requirements. The RT latency requirements may include uplink delay information and/or downlink delay information. The device may generate first policy charging and control (PCC) rules, for example based on the uplink delay information and/or the downlink delay information. The device may send first information indicating the first PCC rules, for example to a session management function (SMF). The device may receive a notification that one or more of an uplink delay and/or a downlink delay is associated with a flow. The notification may include an indication that one or more of the uplink delay and/or the downlink delay associated with the flow is not within a range that is required by the first PCC rules. The device may determine second PCC rules, for example based on the uplink delay information and the downlink delay information. The device may send second information indicating the second PCC rules, for example to the SMF. The message may include one or more of a multi-modal service identifier (ID) and/or one or more traffic descriptors. The one or more traffic descriptors may include an indication of one or more of an uplink data flow and/or a downlink data flow.

The device may send a (e.g., second) notification, for example to an application function (AF). The notification may include an indication that PCC rules that meet one or more of the RT latency requirements, the uplink delay information, and/or the downlink delay information cannot be generated. The RT latency requirements may include first RT latency requirements. The uplink delay information may include first uplink delay information. The downlink delay information may include first downlink delay information. The device may determine second RT latency requirements. The second RT latency requirements may include second uplink delay information and/or second downlink delay information. The device may determine third PCC rules, for example based on the second RT latency requirements. The device may send the third PCC rules to the SMF.

The uplink delay information may include an indication of one or more of a maximum uplink packet delay budget (PDB) and/or a maximum uplink protocol data unit (PDU) set delay budget (PSDB). The downlink delay information may include an indication of one or more of a maximum downlink PDB and/or a maximum downlink PSDB. The device may include a policy control function (PCF). The device may generate N4 rules, for example based on the second PCC rules. The device may send one or more of a quality of service (QOS) profile to an access network and/or a QOS rule to a wireless transmit/receive unit (WTRU). The flow associated with the one or more of the uplink delay and/or the downlink delay may additionally, or alternatively, be associated with one or more of the first PCC rules and/or the second PCC rules.

A device may receive protocol data unit (PDU) set delay budget (PSDB) information, for example from an application function (AF). The PSDB information may indicate a first PSDB value for PDU set sizes above a threshold and/or a second PSDB value for PDU set sizes below the threshold. The device may generate a rule. The rule may indicate that PDU sets with set sizes less than the threshold should be assigned to a first quality of service (QOS) flow and/or that PDU sets with set sizes greater than the threshold should be assigned to a second QoS flow. The device may send information indicating the rule, for example to one or more of a wireless transmit/receive unit (WTRU), a user plane function (UPF), or a radio access network (RAN).

The rule may include an indication of a QOS profile, which for example may indicate that PDU sets from a first QOS flow with set sizes that are less than the threshold should be associated with the first PSDB value. The QoS profile may additionally, or alternatively, indicate that PDU sets from the first QoS flow with set sizes that are greater than the threshold should be associated with the second PSDB value. The device may include a session management function (SMF). The device may receive policy charging and control (PCC) rules, for example from a policy control function (PCF). The device may generate N4 rules, for example based on the PCC rules. The device may send information indicating the N4 rules, for example to a user plane function (UPF). The device may send an indication of whether one or more of the first QoS flow and/or the second QoS flow are within a delay range required by the rule. The rule may include an indication of a QoS rule that, for example may indicate that PDU sets that match a first packet detection rule and/or have set sizes that are less than a threshold should be associated with the first QoS flow. The QoS rule may additionally, or alternatively, indicate that PDU sets that match the first packet detection rule and/or have set sizes that are greater than the threshold should be associated with a second QoS flow. An indication of the threshold may be included in the PSDB information.

### BRIEF DESCRIPTION OF THE DRAWINGS

A more detailed understanding may be had from the following description, given by way of example in conjunction with the accompanying drawings, in which like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A.

FIG. 1C is a system diagram illustrating an example radio access network (RAN) and an example core network (CN) that may be used within the communications system illustrated in FIG. 1A.

FIG. 1D is a system diagram illustrating a further example RAN and a further example CN that may be used within the communications system illustrated in FIG. 1A.

FIG. 2 illustrates an example procedure to configure multi-modal requirements.

FIG. 3 illustrates an example procedure to configure QOS monitoring.

### DETAILED DESCRIPTION

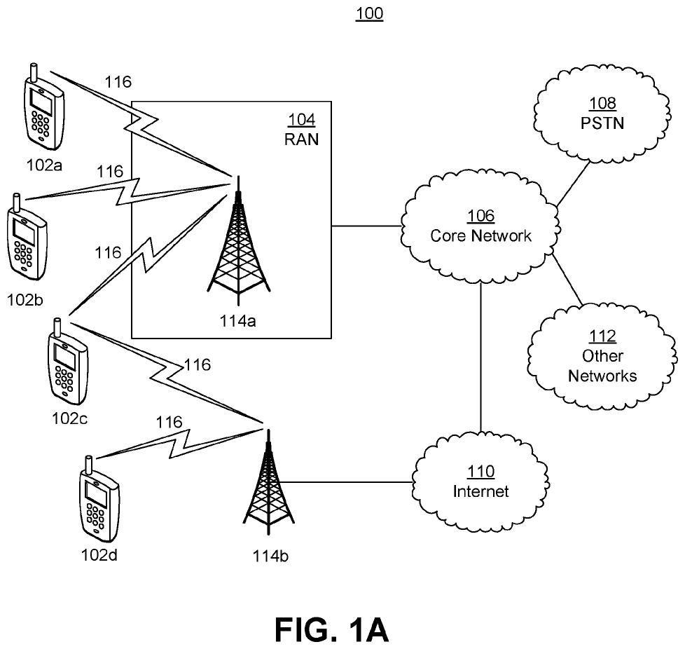

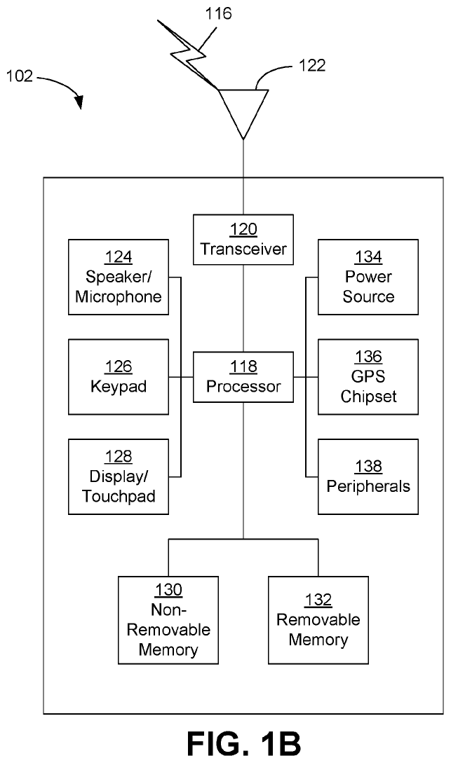

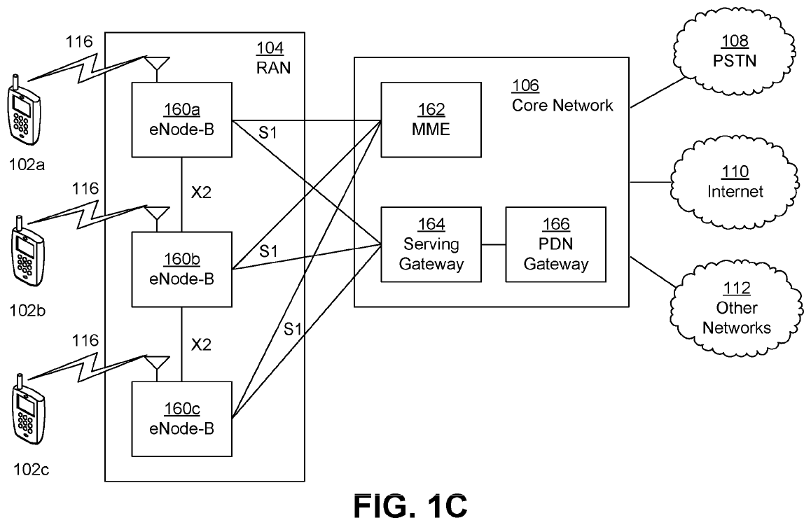

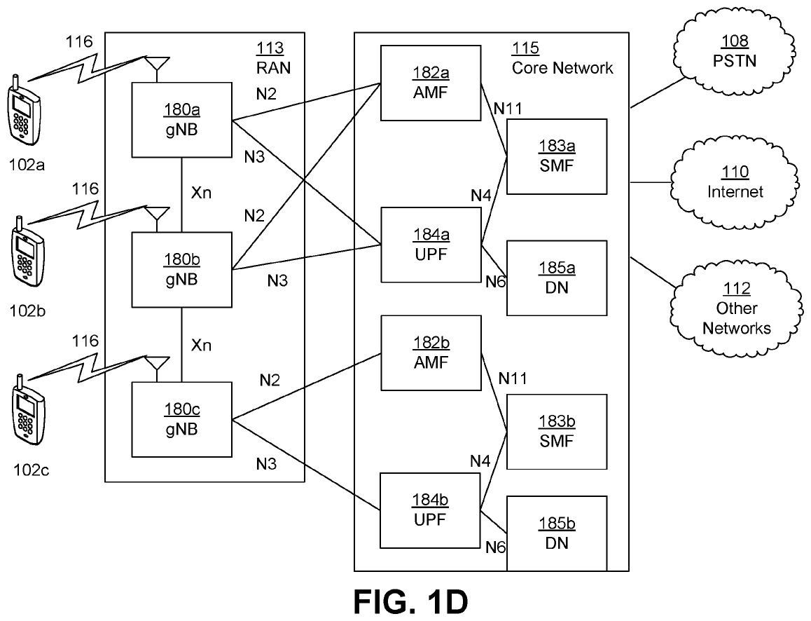

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUS 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUS 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, in which the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A network (NW) may be configured with RT latency information (e.g., latency requirement). Additionally, or alternatively, the NW may be configured with information (e.g., beyond the RT latency requirement), for example at a policy control function (PCF). The information may include one or more of a maximum uplink delay and/or a maximum downlink delay. Uplink delay and/or downlink delay may include a protocol data unit (PDU) set delay budget (PSDB). For example, configuring the uplink delay and/or downlink delay to be (e.g., include) a PSDB may allow an application function (AF) to configure a round trip time requirement. The round trip time requirement may be for a scenario in which traffic in one direction carries PDU set(s) and/or traffic in another direction carries PDU(s) that are not part of a PDU set.

A session management function (SMF) may receive PSDB information, for example from the PCF. The PSDB information may be used to determine a PSDB of a PDU set. The PSDB information may include a PSDB determination rule that, for example may map one or more traffic characteristics to a PSDB. One or more of the traffic characteristics may relate to the size of a PDU set. The network, for example the SMF, may use the PSDB information to construct one or more rules. The one or more rules may be N4 rules. The SMF may send the one or more rules (e.g., information indicating the one or more rules), for example to a user plane function (UPF). The network (e.g., SMF) may send information indicating the rule, for example to one or more of a wireless transmit/receive unit (WTRU), a user plane function (UPF), or a radio access network (RAN). The one or more rules may include packet detection rule(s). The one or more rules may indicate, for example to the UPF, that PDU set(s) that match a certain packet detection rule and/or are less than a certain size should be assigned to a (e.g., certain) quality of service (QOS) flow. The flow may be associated with the one or more of the uplink delay or the downlink delay. Additionally, or alternatively, the flow may be associated with one or more of the (e.g., first) PCC rules and/or the (e.g., second/new) PCC rules.

The NW, for example the PCF, may receive a message. The message may include RT latency requirements The message may be received from the AF. The RT latency requirements may include uplink delay information and/or downlink delay information. For example, the message may include a multi-modal service identifier (ID). Additionally, or alternatively, the message may include one or more traffic descriptors that, for example may identify uplink and/or downlink data flows. Uplink delay information may indicate (e.g., represent) a maximum uplink PDB and/or a maximum uplink PSDB. Additionally, or alternatively, the uplink delay information may indicate a percentage that represents the maximum percentage of the RT latency requirement that may be applied to the uplink traffic. Downlink delay information may represent a maximum downlink PDB and/or a maximum downlink PSDB. Additionally, or alternatively, the downlink delay information may indicate a percentage that represents the maximum percentage of the RT latency requirement that may be applied to the downlink traffic.

The NW, for example the PCF, may use the uplink delay information and/or downlink delay information to generate (e.g., create) PCC rules. The PCF may send information indicating the PCC rules to an SMF. The network, for example the PCF, may receive a notification that the delay that is associated with a flow (e.g., QOS flow) is not within the range that is required by the PCC rule. The NW, for example the PCF, may determine (e.g., new) PCC rules. The NW may determine the PCC rules based on (e.g., receiving) the notification. For example, based on receiving the notification, the PCF may use the uplink delay information and/or downlink delay information to determine new PCC rules. The uplink delay information and/or downlink delay information may include new (e.g., updated) uplink delay information and/or downlink delay information. The PCF may send the new PCC rules, for example to the SMF.

The PCF may (e.g., based on receiving the notification) determine that the PCC rules that meet (e.g., all of) the requirements cannot be created. A requirement may be indicated in one or more of the RT latency requirements, uplink delay information, and/or downlink delay information. The PCF may send a notification to an AF, for example based on the determination that the PCC rules that meet (e.g., all of) the requirements cannot be created. The notification may include an indication of whether one or more of the uplink delay and/or downlink delay cannot (e.g., or can) be met. The PCF may, for example based on (e.g., receiving) the notification, determine one or more of a new set of RT latency requirements, uplink delay information, and/or downlink delay information. The PCF may calculate new PCC rules, for example based on the new set of RT latency requirements, uplink delay information, and/or downlink delay information. The PCF may use the new uplink delay information and/or downlink delay information to determine new PCC rules. The PCF may send the new PCC rules, for example to the SMF. The new set of RT latency requirements, uplink delay information, and/or downlink delay information may be based on a set of values that, for example was (e.g., previously) provided by the AF. The PCF may send a notification to an AF, for example to notify the AF that the new set of value was used.

The NW, for example the SMF, may be configured to determine QoS requirements. For example, the NW may determine QoS requirements based on one or more PDU set attributes. The NW, for example the SMF, may receive PSDB information. The PSDB information may be received from a PCF. The PSDB information may be used to determine a PSDB of a PDU set. The PSDB information may include a PSDB determination rule that, for example maps traffic characteristics to a PSDB. At least one of the characteristics may relate to the size of a PDU set.

The NW, for example the SMF, may use the PSDB information to construct N4 rules and/or send the N4 rules. The NW may send the N4 rules to the UPF. The N4 rules may include packet detection rules. The N4 rules may indicate, for example, to the UPF that PDU sets that match a first packet detection rule and/or are less than a certain size should be assigned to a first QoS flow. Additionally, or alternatively, the N4 rules may indicate that PDU sets that match the first packet detection rule (e.g., the same rule) and/or are greater than or equal to a certain size should be assigned to a second QOS flow. Size information may be included with (e.g., integrated into) the packet detection rule. The NW, for example the SMF, may use the PSDB information to construct a QOS profile. The NW may send the QoS profile, for example to the RAN. The QoS profile may indicate, for example to the RAN, that PDU sets from a first QoS flow that are less than a certain size should be associated with first a PSDB. Additionally, or alternatively, the QoS profile may indicate, for example to the RAN, that PDU sets from the first QoS flow (e.g., the same QoS flow) and/or are greater than or equal to the same certain size should be associated with a second PSDB.

The NW, for example the SMF, may use the PSDB information to construct QoS rules. The NW may send the QOS rules, for example to the WTRU. The SMF may send a QoS rule that indicates (e.g., to the WTRU) that PDU sets that match a first packet detection rule and/or filter, and/or are less than a certain size (e.g., a threshold) should be assigned to a first QOS flow. The SMF may send an indication (e.g., to the WTRU) that PDU sets that match the first packet detection rule and/or filter, (e.g., the same filter) and/or are greater than or equal to a certain size (e.g., a threshold) should be assigned to a second QoS flow. The indication may be sent as part of the indicated QoS rule and/or as a new QoS rule. Size information may be included with (e.g., integrated into) the packet detection rule and/or filter.

The PSDB determination rule and/or QoS profile may indicate that any PDU set whose size is less than or equal to a first value may have a PSDB of a second value. The PSDB determination rule may indicate that any PDU set whose size is greater than the first value has a PSDB of a third value. The N4 rule and/or QoS rule may indicate that a (e.g., any) PDU set whose size is less than equal to a first value should be assigned to a first QoS flow. The PSDB determination rule may indicate that a (e.g., any) PDU set whose size is greater than the first value should be assigned to a second QoS flow. The PSDB determination rule and/or QoS profile may include any number of PDU set size to PSDB mappings. The N4 rule and/or QOS rule may include any number of PDU set size to QoS flow mappings. The PDU set size in one or more of the PSDB determination rule, QoS profile, N4 rule, and/or QoS rule may be expressed as the total number of bytes in the PDU set and/or the total number of PDUs in the PDU set. The PSDB determination rule and/or QOS profile may indicate a (e.g., single) time value. The SMF and/or RAN may determine the PSDB, for example by multiplying the PDU set size by the time value. For example, the time value may be multiplied by the number of PDUs in the PDU set and/or the number of bytes in the PDU set. The PSDB determination rule may be included in the N4 rule and/or QoS rule. The PSDB determination rule may be a standalone rule.

The WTRU may be configured to determine a QoS flow assignment, for example based on one or more PDU set attributes. The WTRU may receive QoS rules, for example from the SMF. The QoS rule may indicate (e.g., to the WTRU) that PDU sets that match a first packet detection rule and/or filter, and/or are less than a certain size should be assigned to a first QOS flow. Additionally, or alternatively, the QOS rule may indicate that the PDU sets that match the first packet detection rule and/or filter, (e.g., the same filter) and/or are greater than or equal to a certain size should be assigned to a second QoS flow. Size information could also be integrated into the packet detection rule and/or filter.

The WTRU may assign PDUs of PDU sets to QOS flows, for example based on the size information in the received QoS rule. The QoS rule may indicate that any PDU set whose size is less than equal to a first value should be assigned to a first QoS flow. Additionally, or alternatively, the QoS rule may indicate that any PDU set whose size is greater than the first value should be assigned to a second QoS flow. The QoS rule may include a (e.g., any) number of PDU set size to QoS flow mappings.

The NW may be configured with a PSDB. The network, for example an AF, may provide PDU set related assistance information for dynamic PCC control. The PDU set related assistance information may include one or more parameters. A parameter may be included in PDU set QoS parameters. A parameter may include PDU set delay budget. The PDU set delay budget (PSDB) may correspond to a maximum (e.g., threshold) for a delay. The delay may be a delay that a PDU set may experience for the transfer between the WTRU and an N6 termination point, for example at the UPF. The delay may include a duration between the reception time of the first PDU (e.g., at the N6 termination point for DL and/or the WTRU for UL) and the time when all PDUs of a PDU set have been successfully received (e.g., at the WTRU for DL or N6 termination point for UL). PSDB may apply to one or more of the DL PDU set received by the PDU session anchor (PSA) UPF over the N6 interface and/or to the UL PDU set sent by the WTRU. The PSDB may supersede the packet delay budget (PDB), for example when the PSDB is available.

The NW may be configured with uplink and/or downlink policy control, for example for XRM services. The NW may be configured with uplink and/or downlink policy control (e.g., for XRM services) based on round-trip (RT) latency. An RT latency indication may indicate that the service data flow needs to meet the RT latency requirement of the service. The RT latency requirement may be twice a single direction delay requirement between the WTRU and the PSA UPF, for example described by a QOS Reference parameter and/or individual QOS parameter.

Enhancements to a 5G system may allow for policy control, for example based on a round-trip latency requirement. The AF may indicate, for example to the PCF, that a UL flow and/or DL flow need to meet a RT latency requirement. The RT latency requirement may include a maximum (e.g., threshold), for example for the sum of UL delay and DL delay of a data flow between the WTRU and N6 termination point, for example at the UPF. The PCF may monitor the delay on (e.g., both) the UL and/or DL flows. The PCF may adjust the UL PDB and/or DL PDB, for example based on observed network performance.

XRM traffic may be carried using PDU sets. The QOS flow may not be associated with any PDB, for example when a QoS flow carries PDU sets. The QoS flow may be (e.g., only) associated with PSDB. For example when PDU sets are carried in one direction of flow, an associated flow of the other direction might not carry PDU sets. Downlink traffic may be based on PDU sets, for example in some XRM scenarios. Additionally, or alternatively, corresponding uplink traffic may correspond to a data flow that does not carry PDU sets. For example when a user is using VR glasses and/or tactile gloves for an XRM service, the downlink traffic that is fed to the VR glasses and/or the tactile gloves may be in the form of PDU sets (e.g., PDU sets for a video modality). The uplink traffic may carry posture information, for example to inform the application server of the user posture and/or haptic feedback. The posture information and/or haptic feedback might not be carried using PDU sets (e.g., using regular PDUs). A downlink flow may carry PDU sets, and/or an (e.g., associated) uplink flow may carry acknowledgements and/or haptic feedback (e.g., traffic that is not carried in PDU sets). A (e.g., extra) margin may be added to the UL PDB, for example when the delay of the DL traffic is under the PSDB. A (e.g., extra) margin may be added to the downlink PSDB, for example when the delay of the uplink traffic is under the PDB.

The system should not (e.g., always) assume that (e.g., all) of the uplink delay margin should be added to downlink PSDB. For example, some or none of the uplink delay margin may be added to downlink PSDB. The downlink traffic may carry updated scene information and/or the uplink traffic may carry acknowledgements of the updated scene information. There may be a decreased quality of user experience, for example as the user may perceive a delay in viewing scene changes from delayed reception of the updated scene information. Experience quality may degrade, for example when round-trip time delay is evenly distributed between an uplink and a downlink flow.

The XRM application service provider may be configured with/learn (e.g., efficient) combinations of UL/DL delays, for example if the XRM application service provider is exposed to detailed uplink and/or downlink delay information. The XRM application service provider may configure (e.g., customize) the UL/DL configuration, for example to best fit the XRM application. Additionally, or alternatively, the XRM traffic may include more than one uplink and/or one downlink flow, for example for each modality and/or for the same modality. UL/DL granularity may help the application provider adjust the requirement over multiple flows. Round-trip delay measurements, for example that are based on measuring the delay that is associated with individual packets, may not be sufficient. For example RT delay measurements that are based on measuring the delay that is associated with individual packets may not be sufficient when PDU sets are sent in the uplink and/or downlink directions. 5G system enhancements are provided herein, for example in which the AF may configure a RT latency requirement for an uplink and/or downlink flow (e.g., combination). The uplink flow and/or downlink flow may carry PDU sets. The AF may measure the delays that are associated with the flow combinations. The AF may adjust the PSDB and/or PDB of a flow, for example based on the configuration information and/or measurement information.

Some applications may (e.g., need to) control latency for (e.g., a combination of) more than one uplink and/or one downlink flow. The timing and/or quality of experience (QoE) for an application, for example may depend on the combination of two downlink media flows and one uplink data flow. Systems and procedures described herein, for example for one UL and one DL flow, may be used to enable AF (e.g., to support such cases). The procedures described herein may specify UL and/or DL delays for three flows or more, for example such that the delay combination provides the required round-trip time (RTT) for application traffic.

A 5G system may allow an AF to provide a PDU set delay budget (PSDB), for example to the 5GC. The 5GC may associate the PSDB with a QoS flow. Associating the PSDB with a QoS flow may correspond to the PCF using the PSDB to construct a PCC rule that may sent to the SMF and/or the SMF sending the PSDB to NG-RAN, for example as part of the QoS profile. The 5G system may support enhancements that account for variation in the size of PDU sets in an application layer session (e.g., a real-time transport protocol (RTP) session). A single PSDB configured for a session may not be sufficient, for example when the size of PDU sets in an application layer session (e.g., an RTP session) may vary. The PSDB may be set to a value that is large enough to accommodate the largest expected PDU set that might be sent in an application layer session, for example when a (e.g., single) PSDB is provided. The 5G System, including NG-RAN for example, may assume the same PSDB value (e.g., even when handling relatively small PDU sets from the same application layer session). The 5G system may allow for too much delay when handling relatively small PDU sets, for example when assuming the same PSDB value.

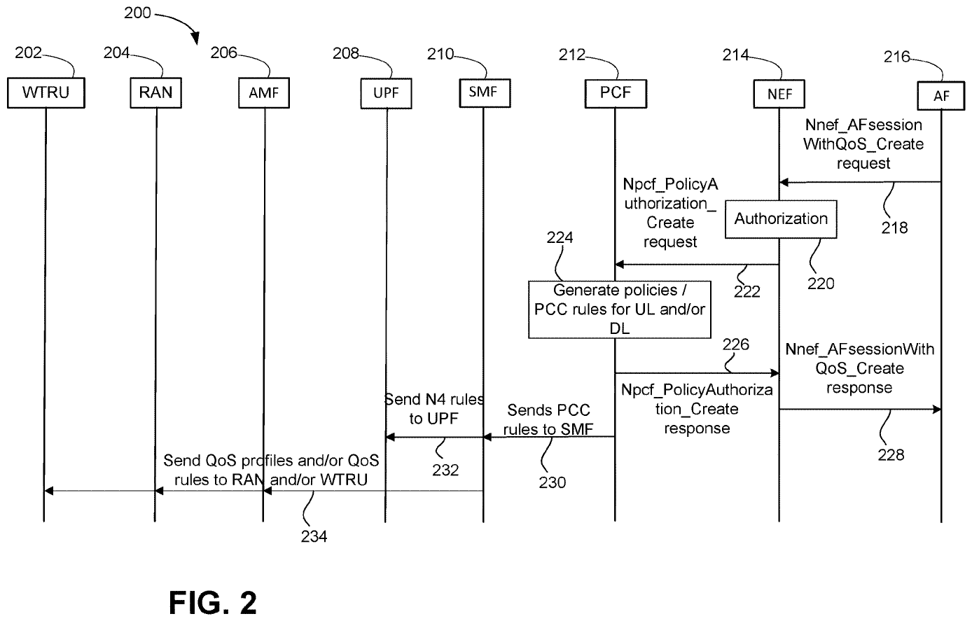

The NW may be configured to provision PDU set(s) aware round-trip latency requirement in the 5GS. FIG. 2 illustrates an example procedure 200 for configuring multi-modal requirements. The example procedure 200 may correspond to an application function requesting to configure requirements for a multi-modal XRM session with a WTRU 202 through the 5GS and/or providing requirements related to round-trip latency. A process may include configuring the 5GS with requirements related to round-trip latency, for example to serve the multi-modal traffic between an application server and the WTRU.

At 218 the NW, for example an AF 216, may request to set up a multi-modal session, for example with the WTRU 202 (e.g., via the 5GS). The AF 216 may request to set up the multi-modal session by invoking an NEF 214 application programming interface (API). The NEF 214 API may be based on (e.g., modeled after) an Nnef_AFsessionWithQoS service operation. In the request for example, the AF 216 may provide service information. The service information may include one or more of flow description information, a WTRU address, and/or a DNN/S-NSSAI combination. The AF 216 may provide, for example in the request, service requirements related to the multi-modal service, for example including a QOS monitoring requirement and/or QoS parameters. QoS parameters may include one or more of a packet delay budget (e.g., for each modality) and/or flow. The AF 216 may provide PDU set QoS parameters, for example in the request. The QoS parameters may include one or more of a PDU set delay budget (e.g., for each modality) and/or flow.

The AF 216 may provide RT latency requirements, for example for the XRM service. The RT latency requirements may include one or more of an RT latency requirement, a UL maximum delay, and/or a DL maximum delay. The RT latency requirement may represent a maximum threshold, for example for the sum of UL delay and DL delay of a data flow between the WTRU and N6 termination point (e.g., at the UPF). The UL maximum delay (e.g., threshold) may represent a maximum UL PDB and/or a maximum UL PSDB. Alternatively, or additionally, the UL maximum delay may indicate a percentage that, for example represents the maximum percentage of the RT latency requirement that may be applied to the UL traffic. The percentage that represents the maximum percentage of the RT latency requirement may change with time. The AF 216 may provide a time window as to when the percentage is valid. The AF 216 may provide different percentages with a time window for each percentage. The DL maximum delay (e.g., threshold) may correspond to a maximum DL PDB or a maximum DL PSDB. Alternatively, or additionally, the DL maximum delay may indicate a percentage that represents the maximum percentage of the RT latency requirement that, for example may be applied to the DL traffic. The percentage that represents the maximum percentage of the RT latency requirement may change with time. As such, the AF 216 may provide a time window as to when the percentage is valid. The AF 216 may provide different percentages with a time window for each percentage.

The AF 216 may provide multiple sets of RT latency, UL maximum delay, and/or DL maximum delay. A PCF 212 may choose the combination of RT latency, UL maximum delay, and/or DL maximum delay to apply. The PCF 212 decision of which combination of RT latency, UL maximum delay, and/or DL maximum delay to apply may be based on measurement reports, for example that the PCF 212 receives. The measurement reports may relate to the measured delay on the associated uplink and/or downlink paths.

Providing an UL maximum delay and/or DL maximum delay, in addition or alternative to providing a RT latency requirement, may be advantageous, for example for when UL and/or DL flows carry PDU sets. The UL maximum delay and/or DL maximum delay may be used by the PCF 212, for example to limit increases in the UL and/or DL delay budgets. The NW may limit how the RT latency is divided between the uplink and downlink flows.

The AF 216 may provide a set of QoS parameters, for example for different configuration(s) for a (e.g., certain) modality. The AF 216 may identify the different modalities (e.g., identified by their traffic descriptors), for example with a multi-modal service ID. For example, for a video modality, the AS may expect a certain value for the frame rates and/or provide QoS parameters for each frame rate value. The AF 216 may provide RT latency requirements, for example for one or more configuration. A set of requirements and QOS parameters may be indexed by a certain integer value. By indexing the set of requirements and QoS parameters by a certain integer value for example, the 5GS and the AS may more easily communicate. For example, the AS and 5GS may communicate regarding determining (e.g., selecting) a configuration for the XRM traffic modality (e.g., different index for different frame rate). The configuration of the modality may change, for example due to a request from the AF and/or due to changes in the network conditions. The 5GS may determine (e.g., relevant) RT latency requirements, for example using the index of a (e.g., new) configuration (e.g., the configuration in use). The AF 216 may provide a multi-modal service ID, for example when the AF 216 provides the RT latency requirements. The multi-modal service ID may be an identifier that associates multi-modal flows, for example belonging to the same multimodal service. The AF 216 may provide an identifier of a packet detection rule, for example when the AF 216 provides the RT latency requirements. The identifier of the packet detection rule may, for example, be used by the network to detect which traffic applies to the rules.

At 220 the NW, for example the NEF 214, may authorize the request from the AF 216. At 222 the NW (e.g., the NEF 214) may send a policy authorization request, for example to a PCF 212. The NW (e.g., NEF 214) may send information, for example that was provided by the AF 216 (e.g., at 218), to the PCF 212. The information may include one or more of the RT latency requirements, traffic flow descriptors, WTRU address, and/or multi-modal service ID, The NEF 214 may alternatively, or additionally, send a list of (e.g., alternative) RT latency requirements. The NEF 214 may send information to the PCF 212 by invoking the PCF 212 Npcf_PolicyAuthorization create and/or update service operation.

At 224 the NW, for example the PCF 212, may authorize the request. At 224 the PCF 212 may, additionally, or alternatively, generate one or more policies, for example for the multi-modal service (e.g., PCC rules). For RT latency requirement(s) for example, the PCF 212 may generate two PCC rules. One PCC rule may relate to an uplink flow and/or another PCC rule may relate to a downlink flow. The uplink flow may be associated with the downlink flow. For example, the uplink flow may be associated with a PDB and/or the downlink flow may be associated with a PSDB.

The PCF 212 may use the RT latency requirements (e.g., RT latency requirement, UL maximum delay, and/or DL maximum delay) to (e.g., initially) assign the PCC rules to the uplink and/or downlink flows. The PCF 212 may create PCC rules, for example when the UL maximum delay is larger than the DL maximum delay. The PCC rules may be such that the PDB that is associated with the uplink flow is larger than the PSDB that is associated with the downlink flow. Additionally, or alternatively, the PCC rules may indicate that the sum of the UL PDB and the DL PDSB should be less than or equal to RT latency requirement.

The PCF 212 may generate QoS monitoring rules for the UL data traffic and/or DL PDU set traffic, for example to track the RT latency. The PCF 212 may associate the (e.g., two) QoS monitoring rules with (e.g., using) a common identifier. The common identifier may include a multi-modal Service ID.

At 226 the NW, for example the PCF 212, may send a policy authorization response, for example to the NEF 214. The NEF 214 may receive the policy authorization response, for example via PCF 212 Npcf_Policy Authorization create response message. The NW (e.g., NEF 214) may send (e.g., forward) the PCF 212 response to the AF 216. At 230 the NW, for example the PCF 212, may send the PCC rules, for example to an SMF 210. At 232 the SMF 210 may send N4 rules to a UPF 208. At 234 the NW, for example the SMF 210, may send QoS rules, for example to the WTRU 202. The SMF 210 may send QoS profiles to the RAN 204. The PCF 212 may generate correlated QoS monitoring policies for the UL data and/or DL PDU set flow.

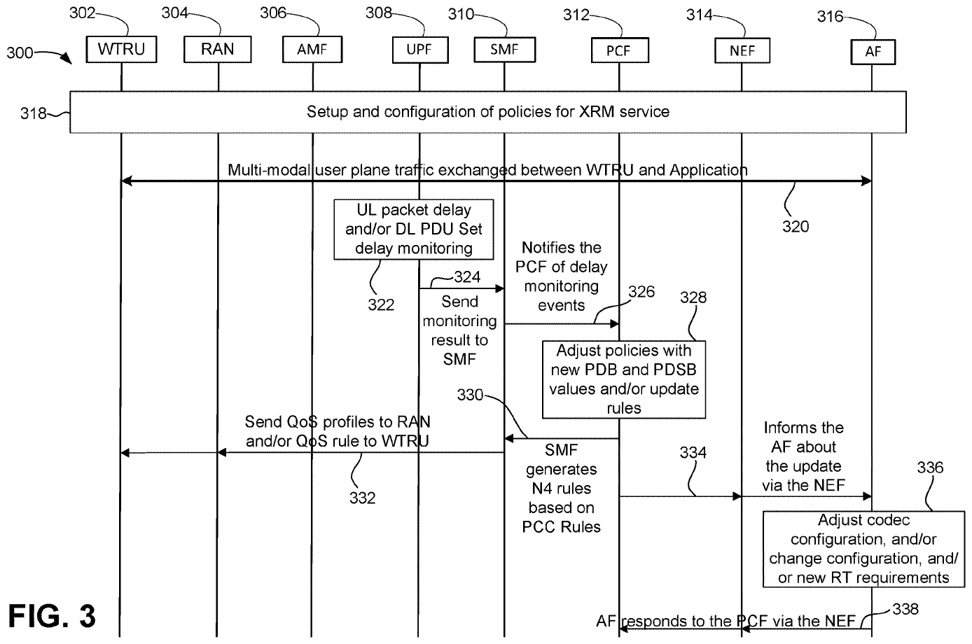

The NW may be configured for behavior using QoS monitoring report for RT latency. FIG. 3 illustrates an example procedure 300 for configuring QoS monitoring. Systems and procedures may, for example, correspond to when a multi-modal service has been established between an AF 316 and the WTRU 302 (e.g., with RT latency requirement provisioned). Systems and procedures describe a monitoring aspect related to the RT latency measurement and/or NW and application behavior, for example as a result of the QOS delay monitoring reports.

At 318 the NW (e.g., an AF 316) may request a session, for example with specific requirements, for the multi-modal service. The AF 316 may request the session, for example using a procedure as herein (e.g., as in FIG. 2). The session (e.g., request) may be to establish and/or configure the policies for an XRM service. At 320 one or more of policies for the XRM traffic and QoS profiles, QOS rules, and/or N4 rules may be established. Additionally, or alternatively, QoS monitoring for UL data and/or DL PDU set delay may be established, for example for RT latency tracking. The WTRU 302 and the application server may exchange XRM traffic, for example through the user plane.

At 322 the NW, for example the UPF 308, may (e.g., start to) perform QOS monitoring, for example after the user plane connection is established and/or traffic is exchanged between the WTRU 302 and the AF 316. The UPF 308 may perform QoS monitoring, for example for delay measurement related to the RT latency. The UPF 308 may perform QOS monitoring for delay measurement related to the RT latency based on a QOS monitoring policy, for example generated by the PCF 312. In the uplink direction for example, the UPF 308 may monitor the UL data packet delay between the WTRU 302 and the N6 termination point. In the downlink direction for example, the UPF 308 (e.g., with the assistance of NG-RAN 304 and/or WTRU 302) may monitor the DL PDU set delay between the N6 termination and the WTRU 302. The (e.g., two) monitoring procedures for the uplink direction and/or the downlink direction may be performed at similar (e.g., the same) times. Performing the (e.g., two) monitoring procedures at similar times may allow the UPF 208 to measure the round-trip latency of interest. The round-trip latency of interest may be the sum of the measurement delay of the uplink and downlink.

At 324 the NW, for example the UPF 308, may report the QoS monitoring results (e.g., to the SMF 310). The monitoring results may include one or more of the UL packet delay measurement, the DL PDU set delay measurement, and/or the summation of both delays (e.g., the RT latency measurement). At 326 the NW, for example the SMF 310, may send a notification, for example to the PCF 312. For example the SMF 310 may send a notification to the PCF 312 if the UL packet delay measurement and/or the downlink PDU set delay measurement is not within an acceptable range.

At 328 the NW, for example the PCF 312, may adjust policies with (e.g., new) PDB and/or PDSB rules; and/or update rules, for example when the NW (e.g., the PCF) detects that the PDB and/or the PSDB of a flow is not being met and/or the flow is associated with RT latency requirements. For example, when the NW (e.g., the PCF 312) detects that the PDB and/or the PSDB of a flow is not being met and/or the flow is associated with RT latency requirements, the PCF may calculate (e.g., new) delay budget values for the uplink and/or downlink directions. The PCF 312 may determine a (e.g., new) PSDB for the downlink flow and/or a (e.g., new) PDB for the uplink flow. For example when the PCF determines that the UL PDB is not being met and/or the DL PDSB is being met, the PCF 312 may increase the packet delay budget for the uplink flow and/or reduce the packet set delay budget for the downlink flow. The PCF 312 may additionally, or alternatively, maintain one or more of the UL PDB to be less than the UL maximum delay, the DL PSDB to be less than the DL maximum delay, and/or the sum of the UL PDB and DL PSDB to be less than the RT latency requirement. The PCF 312 may use the RT latency requirements (e.g., the RT latency requirements of procedure 200), for example to determine the (e.g., new) delay budget values. The PCF 312 may generate (e.g., new) PCC rules for (e.g., both) the uplink and/or downlink directions. The PCF 312 may configure the uplink flow to use a (e.g., new) PCC rule and/or configure the downlink flow to a use a (e.g., new) PCC rule.

The PCF 312 may determine that the PCF 312 cannot increase the delay that is allocated to the flow whose PDB or PSDB is not being met, for example when the NW (e.g., the PCF) detects that the PDB and/or the PSDB of a flow is not being met and/or the flow is associated with RT latency requirements. Additionally, or alternatively, the PCF 312 may notify the AF 316 that the QoS requirements cannot be met. For example, the PCF 312 may determine that increasing the delay (e.g., any further) may violate the UL maximum delay and/or DL maximum delay requirement (e.g., the UL maximum delay and/or DL maximum delay requirement of procedure 200). The PCF 312 may notify the AF 316 that the QOS requirements cannot be met, for example when the PCF 312 determines that the PCF 312 cannot increase the delay budget that is allocated to the flow whose PDB and/or PSDB is not being met. The AF 316 may adjust application layer settings (e.g., a codec setting) and/or adjust the QoS requirements, for example by re-initiating the setup and/or configuration of policies for XRM service (e.g., as described in procedure 200) (e.g., to provide a new QoS configuration).

At 330 the NW, for example the PCF 312, may generate rules (e.g., N4 rules), for example based on PCC rules. At 330 the PCF 312 may additionally, or alternatively, send (e.g., forward) the updated (e.g., pair of) PCC rules, for example to the SMF 310. The SMF 310 may send (e.g., forward) the N4 rules, for example to the UPF 308. At 332 the NW, for example the PCF 312, may send (e.g., forward) the updated QoS rules (e.g., to the WTRU 302) and/or the updated pair of QoS profiles (e.g., to the RAN 304), for via the AMF 306.

At 334 the NW, for example the PCF 312, may send (e.g., provide) a notification for information, for example to the AF 316 (e.g., via the NEF 314). The PCF 312 may determine the index of the (e.g., newly selected) PSDB value (e.g., after the update), for example when the AF 316 provided (e.g., alternative) PSDB requirements and/or RT latency requirement. the PCF 312 may send the determined index, for example to the AF 316. At 336 the AF 316 may determine which configuration for the modality to use, for example using the determined index. Additionally, or alternatively, at 336 the AF 316 may one or more of adjust a codec configuration, change a configuration, and or provide (e.g., new) RT requirements. The configuration may include a codec setting, for example for a video modality.

The PCF 312 may inform the AF 316 about the new pair of delay requirements that are selected for UL and/or DL, for example when the PCF 312 was not provided (e.g., alternative) PSDB values, for example by the AF 316. The delay requirements for UL and/or DL may be determined and/or selected to (e.g., continue to) meet the RT latency requirement, for example provided by the AF 316. At 336 the AF 316 may use the information of the pair of delay requirements (e.g., internally), for example to change one or more application parameters. The values of DL PSDB and/or UL PDB sent to the AF 316 may not be indexed by the 5GS, for example if no alternative value is provided (e.g., beforehand) by the AF 316. The PCF 312 may inform the AF 316 that the RT delay measurement exceeds the requirement, for example when the RT delay requirement cannot be met. The PCF 312 may provide the new RT measurement, for example to the AF 316. The AF 316 may provide the (e.g., new) RT measurement. Additionally, or alternatively, the AF 316 may provide one or more of the measured DL PDU set delay, UL PDU delay, and/or an indication of whether the uplink delay and/or downlink delay cannot be met. At 336 the AF 316 may use the provided information to assess and/or change the internal configuration of the AF 316. For example, the AF 316 may change the internal configuration based on the new codec. The AF 316 may provide the 5GS/PCF 312 with (e.g., new) RT latency requirements.

At 338 the NW, for example the AF 316, may respond to the PCF message. For example, the AF 316 may respond to the PCF message by changing application-level information. The AF 316 may change application-level information including the codec setting, for example according to the index of the DL PSDB provided (e.g., at 334) by the PCF 312. The AF 316 may exchange XRM traffic with the WTRU 302 over the user plane, for example using the new codec setting. The AF 316 may confirm the change, for example to the PCF 312 (e.g., via the NEF 314).

The AF 316 may respond to the PCF message by reevaluating the RT latency requirement provided to the 5GS. The AF 316 may provide a (e.g., new) RT latency requirement to the PCF 312, for example via the NEF 314. The PCF 312 may use the RT latency requirement and/or one or more other parameters to derive (e.g., new) PCC rules. For example, the PCF 312 may use the RT latency requirement and/or one or more other parameters to derive new PCC rules. The (e.g., new) PPC rules may include one or more of PCC rules with UL PDB and/or other PCC rules with DL PSDB for the XRM service.

The AF 316 may determine that an acceptable user experience may not be supported for the WTRU 302 with the given network conditions and/or may respond to the PCF message accordingly. For example, the AF 316 may inform the user of such an event. The AF 316 may trigger the WTRU 302 to terminate the user plane exchange, for example for the XRM service.

The NW may be optimized to deal with varying PDU set sizes. The AF 316 may invoke an NEF 314 API, for example to provide the 5GC with information about the PSDB requirements of an application layer session. The application layer session may be used to send and/or receive PDU sets of varying sizes. For example, the NEF 314 API may include the Nnef_AFsessionWithQoS_Create and/or Nnef_AFsessionWithQOS_Update service operations. The procedure to invoke the NEF 314 API may include the same or similar steps as those described herein, for example as in FIG. 2. The AF 316 may use the API to provide PDU set QoS parameters and/or a protocol description of a service data flow, for example to the NEF 314. The protocol description may indicate a protocol and/or payload type, for example used by the service data flow. The PDU set QoS parameters may include PSDB information.

The PSDB information may include a rule. Additionally, or alternatively, the PSDB information may include a threshold (e.g., size). Size and threshold may be used interchangeably herein. The rule may be used by the 5GC to associate PDU set sizes with a PSDB value. For example, the rule may indicate that any PDU set whose size is less than or equal to a first value (e.g., threshold) has a PSDB of a second value. The rule may indicate that any PDU set whose size is greater than the first value (e.g., threshold) has a PSDB of a third value. The rule may include any number of PDU set size to PSDB mappings. The PDU set size may be expressed as the total number of bytes in the PDU set and/or the total number of PDUs in the PDU set. Additionally, or alternatively, the rule may indicate a (e.g., single) time value. The NW may determine the PSDB, for example by multiplying the PDU set size by the time value. The time value may be multiplied by the number of PDUs in the PDU set and/or the number of bytes in the PDU set. Additionally, or alternatively, the rule may indicate a first value and/or value range, for example for an attribute of a PDU set. Additionally, or alternatively, the rule may indicate that any PDU set with an attribute value equal to the first value and/or within the range has a PSDB of a second value. The attribute of the PDU set may include one or more an association to layer ID “0”, independence from other PDU sets payload for decoding, dependence on other PDU sets payload for decoding, and/or a PDU set to importance “1”. The attribute may be specified using an ID (e.g., independent PDU set, PDU set layer ID, importance, and/or etc.). The rule may include any attribute and/or value to PSDB mapping(s). The NW may determine the PSDB by (e.g., first) obtaining the value of the attribute (e.g., by analyzing transport headers of PDUs) and/or looking up the attribute and/or value in the mapping(s).

The NEF 314 may provide the rule to the PCF 312. The PCF 312 may send the rule to the SMF 310, for example as part of PCC rules. The SMF 310 may include information from the rule in the N4 rules that, for example may be sent by the SMF 310 to the UPF 308. For example, the SMF 310 may send a (e.g., one) N4 rule. The N4 rule may indicate (e.g., to the UPF 308) that PDU sets that match a first packet detection rule and/or are less than a certain size should be assigned to a first QoS flow. Additionally, or alternatively, the N4 rule may indicate (e.g., to the UPF 308) that PDU sets that match the first packet detection rule (e.g., the same rule) and/or are greater than or equal to the same certain size should be assigned to a second QoS flow. The PDU set, PDU, and/or packet may include information, for example in a header. The information may be used to identify traffic, for example that the packet belongs to. If the information (e.g., in the header) matches and/or includes at least some of the same information as information element(s) of a rule (e.g., packet detection rule (PDR)) for example, it may be determined that the packet matches the PDR. The PDR may include information elements that may help identify traffic and/or packets which belong to a certain traffic. The size information may be integrated into the packet detection rule.

The SMF 310 may include information from the rule in the QoS profiles, for example that are sent by the SMF 310 to the RAN 304. For example, the SMF 310 may send a QoS profile that indicates to the RAN 304 that PDU sets from a first QoS flow that are less than (e.g., have sizes less than) a certain size (e.g., a threshold) should be associated with a first PSDB and/or that PDU sets from the first QoS flow (e.g., the same QoS flow) that are greater than or equal to (e.g., have sizes greater than or equal to) a certain size (e.g., a threshold) should be associated with a second PSDB. The SMF 310 may send a QoS profile that indicates to the RAN 304 that PDU sets from a first QoS flow that are associated with certain PDU set attribute values and/or ranges should be associated with a first PSDB. Additionally, or alternatively, the QOS profile may indicate that PDU sets from a first QOS flow (e.g., the same QOS flow) that are associated with other PDU set attribute values and/or ranges should be associated with a second PSDB. To enable this association for example, the UPF 308 may set attribute values in the GTP-U headers of the GTP-U packet used to transport PDUs of the PDU set. Examples of general packet radio service tunnelling protocol user plane (GTP-U) header information elements (IEs) for attribute values may include existing IEs, such as PDU set importance for example. Examples of GTP-U header IEs for attribute values may include one or more of new IEs independent PDU set (e.g., 0 means dependent, 1 independent), a layer ID (e.g., that indicates the decoding layer of the PDU payload), and/or a base layer (e.g., 1 means the PDU payload holds a base layer for decoding, while 0 means it does not).

It is noted that providing the rule information to the UPF and RAN may be alternative options. Additionally, or alternatively, the SMF 310 may include information from the rule in the QOS rules, for example that are sent by the SMF 310 to the WTRU 302. For example, the SMF 310 may send a (e.g., one) QoS rule that indicates (e.g., to the WTRU 302) that PDU sets that match a first packet detection rule and/or filter, and/or are less than a certain size and/or match a certain attribute value/range should be assigned to a first QoS flow. Additionally, or alternatively, the QoS rule may indicate that PDU sets that match the first packet detection rule and/or filter (e.g., the same filter), and/or are greater than or equal to a certain size and/or match another attribute value/range should be assigned to a second QoS flow. The size information and/or the attribute value may be integrated into the packet detection rule and/or filter.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1-18. (canceled)

19. A network entity comprising:
a processor configured to:
receive a message comprising round-trip (RT) latency requirements, the RT latency requirements comprising uplink delay information and downlink delay information;
generate first policy charging and control (PCC) rules based on the uplink delay information and the downlink delay information;
send first information indicating the first PCC rules to a session management function (SMF);
receive a notification that one or more of an uplink delay or a downlink delay is associated with a flow;
determine second PCC rules based on the one or more of the uplink delay or the downlink delay; and
send second information indicating the second PCC rules to the SMF.

20. The network entity of claim 19, wherein the notification is a first notification, and wherein the processor is further configured to send a second notification to an application function (AF), wherein the second notification includes an indication that PCC rules that meet one or more of the RT latency requirements, the uplink delay information, or the downlink delay information cannot be generated.

21. The network entity of claim 19, wherein the RT latency requirements comprise first RT latency requirements, the uplink delay information comprises first uplink delay information, and the downlink delay information comprises first downlink delay information, and wherein the processor is further configured to:
determine second RT latency requirements comprising second uplink delay information and second downlink delay information;
determine third PCC rules based on the second RT latency requirements; and
send the third PCC rules to the SMF.

22. The network entity of claim 19, wherein the uplink delay information comprises an indication of one or more of a maximum uplink packet delay budget (PDB) or a maximum uplink protocol data unit (PDU) set delay budget (PSDB), and wherein the downlink delay information comprises an indication of one or more of a maximum downlink PDB or a maximum downlink PSDB.

23. The network entity of claim 22, wherein one or more of the maximum downlink PDB or the maximum downlink PSDB of the uplink delay information is different than the one or more of the maximum downlink PDB or the maximum downlink PSDB of the downlink delay information.

24. The network entity of claim 19, wherein the message comprises one or more of a multi-modal service identifier (ID) or one or more traffic descriptors.

25. The network entity of claim 19, wherein the network entity comprises a policy control function (PCF).

26. The network entity of claim 19, wherein the notification comprises an indication that one or more of the uplink delay or the downlink delay associated with the flow is not within a range that is required by the first PCC rules.

27. The network entity of claim 19, wherein the processor is further configured to generate N4 rules based on the second PCC rules.

28. The network entity of claim 19, wherein the flow associated with the one or more of the uplink delay or the downlink delay is further associated with one or more of the first PCC rules or the second PCC rules.

29. A method performed by at least one network entity, the method comprising:
receiving a message comprising round-trip (RT) latency requirements, the RT latency requirements comprising uplink delay information and downlink delay information;
generating first policy charging and control (PCC) rules based on the uplink delay information and the downlink delay information;
sending first information indicating the first PCC rules to a session management function (SMF);
receiving a notification that one or more of an uplink delay or a downlink delay is associated with a flow;
determining second PCC rules based on the one or more of the uplink delay or the downlink delay; and
sending second information indicating the second PCC rules to the SMF.

30. The method of claim 29, wherein the notification is a first notification, and wherein the method further comprises sending a second notification to an application function (AF), wherein the second notification includes an indication that PCC rules that meet one or more of the RT latency requirements, the uplink delay information, or the downlink delay information cannot be generated.

31. The method of claim 29, wherein the RT latency requirements comprise first RT latency requirements, the uplink delay information comprises first uplink delay information, and the downlink delay information comprises first downlink delay information, and wherein the method further comprises:
determining second RT latency requirements comprising second uplink delay information and second downlink delay information;
determining third PCC rules based on the second RT latency requirements; and
sending the third PCC rules to the SMF.

32. The method of claim 29, wherein the uplink delay information comprises an indication of one or more of a maximum uplink packet delay budget (PDB) or a maximum uplink protocol data unit (PDU) set delay budget (PSDB), and wherein the downlink delay information comprises an indication of one or more of a maximum downlink PDB or a maximum downlink PSDB.

33. The method of claim 32, wherein one or more of the maximum downlink PDB or the maximum downlink PSDB of the uplink delay information is different than the one or more of the maximum downlink PDB or the maximum downlink PSDB of the downlink delay information.

34. The method of claim 29, wherein the message comprises one or more of a multi-modal service identifier (ID) or one or more traffic descriptors.

35. The method of claim 29, wherein the network entity comprises a policy control function (PCF).

36. The method of claim 29, wherein the notification comprises an indication that one or more of the uplink delay or the downlink delay associated with the flow is not within a range that is required by the first PCC rules.

37. The method of claim 29, further comprising generating N4 rules based on the second PCC rules.

38. The method of claim 29, wherein the flow associated with the one or more of the uplink delay or the downlink delay is further associated with one or more of the first PCC rules or the second PCC rules.
